(19) United States
(12) Patent Application Publication
(10) Pub. No.: US 2019/0020411 A1
(43) Pub. Date: Jan. 17, 2019

(54) METHODS AND APPARATUS FOR EFFICIENT VISIBLE LIGHT COMMUNICATION (VLC) WITH REDUCED DATA RATE

(71) Applicant: QUALCOMM Incorporated, San Diego, CA (US)

(72) Inventors: Ravi Shankar Kadambala, Hyderabad (IN); Bapineedu Chowdary Gummadi, Hyderabad (IN); Pradeep Veeramalla, Hyderabad (IN); Vivek Veenam, Hyderabad (IN)

(21) Appl. No.: 15/649,354

(22) Filed: Jul. 13, 2017

(51) Int. Cl. H04B 10/116

(52) U.S. Cl. CPC H04B 10/116

(57) ABSTRACT

Methods, systems, and devices are described for processing Visual Light Communication (VLC) signals with a reduced number of pixels while maintaining a substantially complete field of view. One method may include receiving one or more VLC signals at an array of pixels and sampling their intensity. The sampling may comprise additively combining analog signals obtained from two or more pixels having like color to generate a plurality of combined VLC signal samples. The VLC signals may be decoded based on a plurality of the combined VLC signal samples.

### BACKGROUND

### 1. Field

The present disclosure relates generally to visible light communications (VLC) via a digital imager.

### 2. Information

Recently, wireless communication employing light emitting diodes (LEDs), such as visible light LEDs, has been developed to complement radio frequency (RF) communication technologies. Light communication, such as Visible Light Communication (VLC), as an example, has advantages in that VLC enables communication via a relatively wide bandwidth. VLC also potentially offers reliable security and/or low power consumption. Likewise, VLC may be employed in locations where use of other types of communications, such as RF communications, may be less desirable. Examples may include in a hospital, on an airplane, in a shopping mall, and/or other indoor, enclosed, or semi-enclosed areas.

### SUMMARY

Briefly, one particular implementation is directed to a method at a mobile device comprising: a method at a mobile device comprising: receiving one or more Visual Light Communication (VLC) signals at an array of pixels; sampling the intensity of the one or more VLC signals at the array of pixels, wherein the sampling comprises sampling a non-consecutive subset of the pixels to generate a plurality of VLC signal samples; and decoding the one or more VLC signals based on a plurality of the VLC signal samples.

Another implementation is directed to a method at a mobile device comprising: receiving one or more Visual Light Communication (VLC) signals at an array of pixels; sampling the intensity of the one or more VLC signals at the array of pixels, wherein the sampling comprises additively combining analog signals obtained from two or more pixels having like color to generate a plurality of combined VLC signal samples; and decoding the one or more VLC signals based on a plurality of the combined VLC signal samples.

Yet another implementation is directed to a mobile device comprising: an array of pixels configured to receive one or more Visual Light Communication (VLC) signals; digital sampling circuitry to sample the intensity of the one or more VLC signals at the array of pixels, wherein the sampling comprises sampling a non-consecutive subset of the pixels to generate a plurality of VLC signal samples; and decoding circuitry to decode the one or more VLC signals based on the plurality of VLC signal samples.

Still another implementation is directed to a mobile device comprising: an array of pixels configured to receive one or more Visual Light Communication (VLC) signals; digital sampling circuitry to sample the intensity of the one or more VLC signals at the array of pixels, wherein the sampling comprises additively combining analog signals obtained from two or more pixels having like color to generate a plurality of combined VLC signal samples; and decoding circuitry to decode the one or more VLC signals based on the plurality of combined VLC signal samples.

It should be understood that the aforementioned implementations are merely example implementations, and that claimed subject matter is not necessarily limited to any particular aspect of these example implementations.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating an embodiment of one architecture for a system including a digital imager;

FIG. 2 illustrates an embodiment of sampling a non-consecutive subset of pixels;

FIG. 3A illustrates an embodiment of additively combining two analog signals from similarly colored pixels to provide a combined analog signal;

FIG. 3B illustrates an embodiment of additively combining four analog signals from similarly colored pixels to provide a combined analog signal;

FIG. 4 is a flow diagram of actions to process light signals according to an embodiment;

FIG. 5 is another flow diagram of actions to process light signals according to an embodiment;

FIG. 6 is a schematic diagram illustrating another embodiment of an architecture for a system including a digital imager; and

FIG. 7 is a schematic diagram illustrating features of a mobile device according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

A typical Visual Light Communication (VLC) system generally may include various VLC devices, such as a light source, which may, for example, comprise an access point (AP), such as a base station, for example. Alternatively, however, as discussed below, for one directional communication, e.g., a downlink without an uplink, for example, a modulating light source may be available that does not necessarily comprise an access point. Likewise, a VLC terminal may comprise a VLC receiver that does not necessarily otherwise communicate (e.g., transmit) VLC signals, for example. Nonetheless, a VLC terminal may, in an example embodiment, likewise comprise a portable terminal such, as a cellular phone, a Personal Digital Assistant (PDA), a tablet device, etc., or a fixed terminal, such as a desktop computer. For situations employing a AP and a VLC terminal in which communication is not necessarily one directional, such as having an uplink and a downlink, so to speak, for example, a VLC terminal may also communicate with another VLC terminal by using visible light in an embodiment. Furthermore, VLC may also in some situations be used effectively in combination with other communication systems employing other communication technologies, such as systems using other wired and/or wireless signal communication approaches, as discussed in more detail later.

VLC signals may use light intensity modulation for communication. VLC signals, which may originate from a modulating light source, may, for example, be detected and decoded by an array of photodiodes, as one example. However, likewise, an imager, such as a digital imager, having electro-optic sensors, such as CMOS sensors and/or CCD sensors, may include a capability to communicate via VLC signals in a similar manner (e.g., via detection and decoding). Likewise, an imager, such as digital imager, may be included within another device, which may be mobile in some cases, such as a smart phone, a tablet or may be relatively fixed, such as a desktop computer, etc.

However, default exposure settings for a digital imager, for example, may more typically be of use in digital imaging (e.g., digital photography) rather than VLC signal communications. As such, default exposure settings may result in attenuation of VLC signals with a potential to possibly render VLC signals undetectable and/or otherwise unusable for communications. Nonetheless, as shall be described, a digital imager (DI) may be employed in a manner so that use in an imager may permit VLC signal communications to occur, which may be beneficial, such as in connection with position/location determinations, for example.

Global navigation satellite system (GNSS) and/or other like satellite positioning systems (SPSs) have enabled navigation services for mobile devices, such as handsets, in typically outdoor environments. However, satellite signals may not necessarily be reliably received and/or acquired in an indoor environment; thus, different techniques may be employed to enable navigation services for such situations. For example, mobile devices typically may obtain a position fix by measuring ranges to three or more terrestrial wireless access points, which may be positioned at known locations. Such ranges may be measured, for example, by obtaining a media access control (MAC) identifier or media access (MAC) network address from signals received from such access points and by measuring one or more characteristics of signals received from such access points, such as, for example, received signal strength indicator (RSSI), round trip delay (RTT), etc., just to name a few examples.

However, it may likewise be possible to employ Visual Light Communication technology as an indoor positioning technology, using, for example, in one example embodiment, stationary light sources comprising light emitting diodes (LEDs). In an example implementation, fixed LED light sources, such as may be used in a light fixture, for example, may broadcast positioning signals using rapid modulation, such as of light intensity level (and/or other measure of amount of light generated) in a way that does not significantly affect illumination otherwise being provided.

Thus, in an embodiment, light fixtures may broadcast positioning signals by modulating generated light output intensity level over time in a VLC mode of communication. Light Emitting Diodes (LEDs) may replace fluorescent lights as a light source, such as in a building, which may potentially result in providing relatively high energy efficiency, relatively low total cost of ownership, and/or relatively low environmental impact, for example.

Unlike fluorescent lighting, LEDs typically are produced via semiconductor manufacturing processes and can modulate light intensity at relatively high frequencies. Using modulation frequencies in a range, such as in the KHz range, as an example, should not generally be perceivable by a typical human eye. However, modulation in this range, for example, may be employed to provide signal positioning. Likewise, to provide and/or maintain relatively consistent energy efficiency in a mode to provide position signaling, simple, binary modulation, as an illustration, may be used in an embodiment, such as pulse width modulation, for example. In general, any one of a host of possible approaches are suitable and claimed subject matter is not intended to be limited to illustrations; nonetheless, some examples include multiple IEEE light modulation standards like On-off keying (OOK), Variable pulse position modulation (VPPM), etc.

In an embodiment, for example, a light fixture may provide a VLC signal with a unique identifier to differentiate a light fixture from other light fixtures out of a group of light fixtures, such as in a venue, for example. A map of locations of light fixtures and corresponding identifiers, such as for a venue, for example, may be stored on a remote server, for example, to be retrieved. Thus, a mobile device may download and/or otherwise obtain a map via such a server, in an embodiment, and reference it to associate a fixture identifier with a decoded VLC signal, in an example application.

From fixture identifiers alone, for example, a mobile device may potentially estimate its position to within a few meters. With additional measurement and processing of VLC signals, a mobile device may potentially further narrow an estimate of its position, such as to within a few centimeters. An array of pixels (e.g., pixel elements) of a digital imager, may be employed for measuring appropriately modulating VLC signals emitted from one or more LEDs, for example. In principle, a pixel in an array of a DI accumulates light energy coming from a relatively narrow set of physical directions. Thus, processing of signals capturing measurements via pixels of an array of a DI may facilitate a more precise determination regarding direction of arrival of light so that a mobile device, for example, may compute its position relative to a light fixture generating modulated signals to within a few centimeters, as suggested. Thus, as an example embodiment, signal processing may be employed to compute position/location, such as by using a reference map and/or by using light signal measurements, such as VLC signals, to further narrow an estimated location/position.

For example, a location of a DI, such as part of a mobile device, for example, with respect to a plurality of locations of a plurality of light fixtures, may be computed in combination with a remote server map that has been obtained, as previously mentioned. Thus, encoded light signals may be received from at least two light fixtures having known (x, y) image coordinates, for example. A direction-of-arrival of respective encoded light signals may be computed in terms of a pair of angles relative to a coordinate system of a receiving device, such as a mobile device, as mentioned. A height of a light fixture with reference to an x-y plane parallel to the earth's surface may be determined (e.g., by computation and/or lookup). Thus, orientation of a mobile device, for example, relative to the x-y plane parallel to the earth's surface may be computed. Likewise, a tilt relative to a gravity vector (e.g., in a z-x plane and a z-y plane) may be measured (e.g., based at least in part on gyroscope and/or accelerometer measurements). Therefore, direction-of-arrival of respective encoded light signals may be computed in terms of a pair of angles relative to the x-y plane parallel to the earth's surface and a location may be computed relative to a map based at least in part on known (x, y) image coordinates of the light fixtures, previously mentioned. Signal processing in this manner might be considered analogous to “beamforming” such as may be used for radio receivers, for example, if multiple light fixtures are employed. Thus, processing signals to compute position relative to one or more fixtures with one or more known fixture locations from one or more decoded identifier may permit a mobile device to determine a position/location, such as global position/location with respect to a venue with cm-level accuracy.

Thus, in an example implementation, positioning signals may potentially be received by a DI, such as may, for example, be mounted in a mobile device, such as a smart phone. For example, a DI may be included as a front-facing digital camera, as simply one example. Sensors, such as electro-optical sensors, included within a DI, for example, may capture line of sight light energy that may impinge upon the sensors, which may be used to compute position, such as in a venue, as suggested above. Captured light energy may comprise signal measurements, such as for VLC signals, for example. Measured VLC signals may be demodulated and decoded by a mobile device to produce a unique fixture identifier. Furthermore, multiple light fixtures if in a field of view (FOV) may potentially be processed.

A digital imager, again, as an example, may comprise an array of pixels (e.g., pixel elements) such as, for example, charged-coupled devices and/or CMOS devices, which may be used for digital imaging. A pixel array, for example, in an embodiment, may comprise several electro-optic devices, that may be responsive to light impinging on a surface of the respective devices. In an embodiment, for example, a film that is at least partially transmissive to light may be formed over individual electro-optic devices to capture (e.g., measure) specific spectral light components (e.g., red, blue and/or green). In one example implementation, as an illustration, different colored trans-missive films may be formed over individual electro-optic sensors in an array in a so-called Bayer pattern. However, processing VLC signals with a full pixel array of a digital imager, for example, may consume excessive amounts of relatively scarce power or may use excessive amounts of available memory, which also comprises a limited resource typically, such as for a mobile device. Furthermore, use of colored transmissive films may also reduce sensitivity to VLC signals.

One approach may be to adjust exposure time for electro-optic sensors of a DI based at least in part on presence of detectable VLC signals; however, one disadvantage may be that doing so may interfere with typical imager operation (e.g., operation to produce digital images). For example, a digital imager, such as for a mobile device, in one embodiment, may employ an electronic shutter to read and/or capture a digital image one line (e.g., row) of a pixel array at a time. Exposure may, for example, in an embodiment, be adjusted by adjusting read and reset operation as rows of an array of pixels are processed. Thus, it might be possible to adjust read and reset operations so that exposure to light from a timing perspective, for example, is more conducive to VLC processing. However, again, a disadvantage may include potential interference with typical imager operation.

According to another approach, it is noted that while a digital imager may capture a frame of light signal measurements, for VLC communications, fewer light signal measurements may be employed with respect to VLC communications without significantly affecting performance so as to potentially reduce power consumption and/or use of limited memory resources, for example. Typically, for example, mobile digital imagers, such as may be employed in a smart phone, as an illustration, may employ a rolling shutter, and sensor measurements may be read line by line (e.g., row by row), as previously mentioned. Thus, relatively high frame rates, such as 240 fps, for example, may consume bandwidth over a bus which may communicate captured measurements for frames of images, such as for operations that may take place between an image processor and memory.

For example a reduced number pixels in an image frame may be processed. Further to this example, only image pixel signals from pixels in isolated regions of an array of pixels, may be processed. Such solutions to reduce power consumption, unfortunately, may not enable processing pixel signals that cover a complete field of view (FOV) or a substantially complete FOV. For example, in an embodiment, a digital imager may be configured to lower power consumption by limiting operation to a particular region (e.g., a 5MP area in a 12MP array) to thereby lower a data rate. Unfortunately, limiting operation of a digital imager to a particular region may reduce FOV coverage, possibly missing a VLC light source of interest.

However, since fewer measurements may be employed in connection with VLC communications, it may be desirable to communicate fewer measurements so that less bandwidth is consumed, which may enable savings in power and/or memory utilization, while still maintaining full, or substantially full, FOV, as suggested.

For example, in an embodiment, instead, to reduce digital sample values, a non-consecutive subset of pixels within a line of pixels may be sampled. For example, in VLC signal processing operations every other pixel, every third pixel or two of every three pixels, and so forth, in a line being read/scanned may be skipped. In this and other embodiments, one or more Visual Light Communication (VLC) signals are received at an array of pixels and the intensity of the one or more VLC signals at the array of pixels is sampled. A non-consecutive subset of the pixels is sampled to generate a plurality of VLC signal samples which may be decoded.

In another embodiment, analog signals from multiple different pixels in a line may be combined to provide a single digital sample value. For example, in a particular implementation, analog signals from two or more similarly colored pixels (e.g., pixels having a matching green, red or blue transmissive light filter) in a line may be additively combined to provide a combined analog signal. The combined analog signal may then be digitally sampled to provide a single digital sample value.

In yet another embodiment, one or more Visual Light Communication (VLC) signals may be received at an array of pixels, and the intensity of the signals may be sampled. The sampling may comprise additively combining analog signals obtained from two or more pixels having like color to generate a plurality of combined VLC signal samples. The one or more VLC signals may be decoded based on a plurality of the combined VLC signal samples.

Using either of the skipping or additive combining processes, or a combination, a number of digital sample values may be reduced while substantially covering a full FOV.

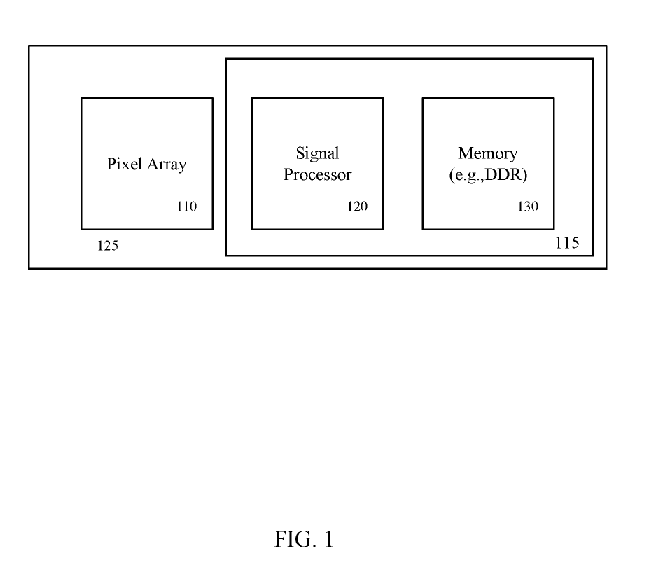

FIG. 1 is a schematic diagram illustrating a possible embodiment, such as 100, of an architecture for processing light signals (e.g., light signal measurements) received at a DI of a mobile device (e.g., in a smartphone). Thus, as illustrated in this example, an imager 125 may include a pixel array 110, a signal processor (SP) 120 and memory 130, such as DDR memory, for example, in one embodiment. As shall be described, circuitry, such as circuitry 115, which includes SP 120 and memory 130, may extract measured VLC signals and measured light component signals for an image from pixels of array 110. For example, an array, such as 110, may include pixels in which light signal measurements that are to be captured may include measurements of light component signals for an image and measurements of VLC signals, as described in more detail below. However, since the respective signals (e.g., VLC signals and light component signals for an image) may undergo separate and distinct downstream processing from the array of pixels in a device, such as a mobile device, it may be desirable to extract one from the other, such as extract VLC signals, for example, from captured measurements. For example, VLC signals and light component signals may be separately assembled from light signal measurements of a captured image so that concurrent processing may take place, in an embodiment.

Extraction, assembly and processing of signals from an array of pixels may be accomplished in a variety of approaches, as described below for purposes of illustration. In addition, in one embodiment, photodiodes, as an example, dedicated to capturing light for VLC signal processing may be employed potentially with reduced power consumption and/or improved measurement sensitivity over typical DI imager sensors, such as CCD and/or CMOS sensors, for example. Pixels for processing light signals, or camera sensor pixels, may be any of the other kinds of sensors, in various embodiments. Of course, claimed subject matter is not intended to be limited to examples, such as those described for purposes of illustration. In embodiments, the camera sensor pixels and the VLC-dedicated pixels may be interleaved. Some implementations may sample the VLC-dedicated pixels independently of the camera sensor pixels. Other implementations may sample the VLC-dedicated pixels in tandem with the camera sensor pixels. However, as alluded to, one possible advantage of an embodiment may include a capability to receive and process VLC signal measurements while concurrently employing a DI to also capture and process light component signal measurements for a digital image. It is noted, as discussed in more detail later, this may be accomplished via a combination of hardware and software in an implementation.

For example, in an embodiment, SP 120 may include executable instructions to perform “front-end” processing of light component signals and VLC signals from array 110. In this example, an array of pixels may be processed row by row, as previously suggested. That is, for example, signals captured by a row of pixels of an array, such as 110, may be provided to SP 120 so that a frame of an image, for example, may be constructed (e.g., assembled from rows of signals), in “front end” processing to produce an image, for example. For measurements that may include VLC signals, those VLC signal measurement portions may be extracted in order to process VLC signals separately from light component signal measurements for an image (e.g., a frame). In this context, the term ‘extract’ used with reference to one or more signals and/or signal measurements refers to sufficiently recovering one or more signal and/or signal measurements out of a group or set of signal and or signal measurements that includes tine one or more signal and/or signal measurements to be recovered so as to be able to further process the one or more signal and/or signal measurements to be recovered to a state in which the one or more signal and/or signal measurements to be recovered are sufficiently useful with regard to the objective of the extraction.

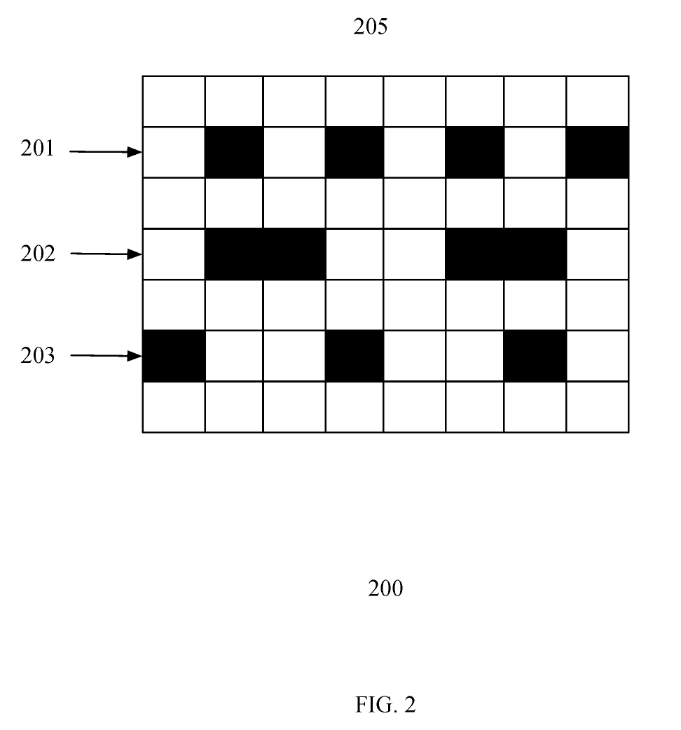

FIG. 2 illustrates an embodiment 200 of sampling a non-consecutive subset of pixels. In FIG. 2, a portion 205 of a pixel array is shown, and three of the rows of the pixel array are labeled 201, 202, and 203. The black pixels are intended to signify pixels that are skipped in a sampling of a non-consecutive subset of pixels. Pixel rows 201, 202 and 203 are illustrative embodiments and not intended to be limiting. For example, pixel row 201 shows, for the portion 205 of the pixel array depicted, skipping every other pixel in a sampling of a non-consecutive subset of pixels. In another example, pixel row 202 shows, for the portion 205 of the pixel array depicted, skipping every third pixel in a sampling of a non-consecutive subset of pixels. In yet another illustrative example, pixel row 203 shows, for the portion 205 of the pixel array depicted, skipping two of every three pixels in a sampling of a non-consecutive subset of pixels. Of course, it is intended that these patterns may continue for the entire row, or for only part of the row, and be combined in a myriad of ways with the other patterns and still be within the scope of claimed subject matter.

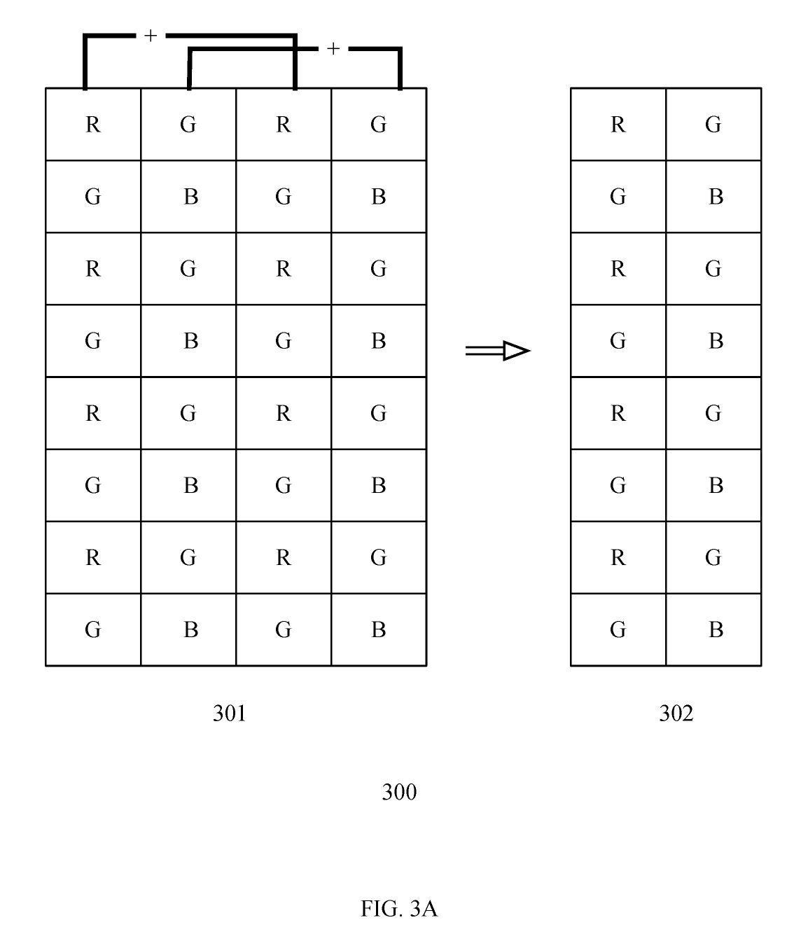

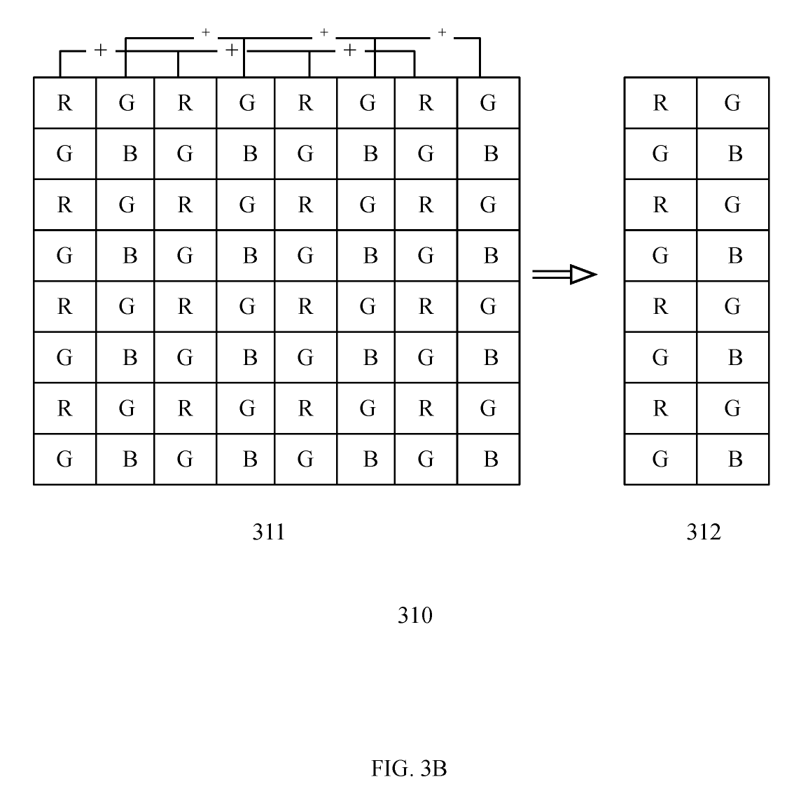

FIG. 3A illustrates an embodiment 300 of additively combining two analog signals from similarly colored pixels to provide a combined analog signal. In FIG. 3A, a portion 301 of a pixel array is shown, and a pixel is labeled with “R”, “G”, or “B” to represent “red”, “green”, or “blue”, respectively. Here, for lines containing red and green pixels, analog signals obtained from two red pixels may be additively combined and sampled to provide a single digital sample value for the combined red pixels. Diagram 302 shows a representation of the resulting single digital sample value for the like-colored pixels combined in portion 301 of a pixel array. Similarly, analog signals obtained from two green pixels may be additively combined and sampled to provide a single digital sample value for the combined green pixels. Likewise, for lines containing green and blue pixels, analog signals obtained from two green pixels may be additively combined and sampled to provide a single digital sample value for the combined green pixels. Similarly, analog signals obtained from two blue pixels may be additively combined and sampled to provide a single digital sample value for the combined blue pixels.

In other embodiments, pixels may be sensitive to different wavelengths of electromagnetic radiation. Some implementations may combine samples from two or more pixels having different colors to generate a plurality of combined VLC signal samples. Various wavelengths and combinations can be used according to the particular way that the VLC signals are encoded.

FIG. 3B illustrates an embodiment 310 of additively combining four analog signals from similarly colored pixels to provide a combined analog signal. In FIG. 3B, like FIG. 3A, a portion 311 of a pixel array is shown, and a pixel is labeled with “R”, “G”, or “B” to represent “red”, “green”, or “blue”, respectively. Here, for lines containing red and green pixels, analog signals obtained from four red pixels may be additively combined and sampled to provide a single digital sample value for the combined red pixels. Diagram 312 shows a representation of the resulting single digital sample value for the like-colored pixels combined in portion 311 of a pixel array. Similarly, analog signals obtained from four green pixels may be additively combined and sampled to provide a single digital sample value for the combined green pixels. Likewise, for lines containing green and blue pixels, analog signals obtained from four green pixels may be additively combined and sampled to provide a single digital sample value for the combined green pixels. Similarly, analog signals obtained from four blue pixels may be additively combined and sampled to provide a single digital sample value for the combined blue pixels.

Processing via SP 120 in accordance with executable instructions may be referred to as software or firmware extraction of VLC signals (e.g., via execution of instructions by a signal processor, such as 120). Thus, in an embodiment, for example, SP 120 may execute instructions to perform extraction of VLC signals and to perform additional processing, such as field of view (FOV) assembly of VLC signals and/or frame assembly of light component signals for an image. It is noted here that FOV assembly of VLC signals may be advantageously performed via execution of instructions on a SP, such as 120. For example, a mobile device may be in motion as signals are captured and, likewise, movement toward or away from a light source, such as a light fixture generating modulating light signals, may lead to dynamic adjustment of a FOV as it is being assembled.

Although claimed subject matter is, of course, not limited to illustrative examples, as one example to provide an illustration, a digital imager may include a mechanism that performs real-time or nearly real-time adjustment with respect to objects within a field of view as a field of view changes. This may include, as non-limiting examples, zooming capability, focus capability, etc. In some imagers, AGC or automatic gain control, such as via an amplifier, may facility such real-time or nearly real-time adjustment. Thus, a similar approach may be employed with regard to dynamic adjustment of a FOV for a digital imager in which signal measurements may also be employed in VLC communications. Thus, in an embodiment, for example, SP 120, for example, may fetch and execute instructions in which to appropriately assemble VLC signals for further processing, such as part of a video front end (VFE), as mentioned below, as an example, as AGC is being adjusted, such as from movement closer or further away from one or more light sources, for example, SP 120 may employ feedback values generated in connection with AGC to dynamically adjust one or more FOVs associated with VLC signals to be processed. Again, as an example, whereas in one situation, a FOV may comprise 640×480 pixels, depending at least in part on distance to a light source, the FOV may be adjusted to include more or fewer pixels.

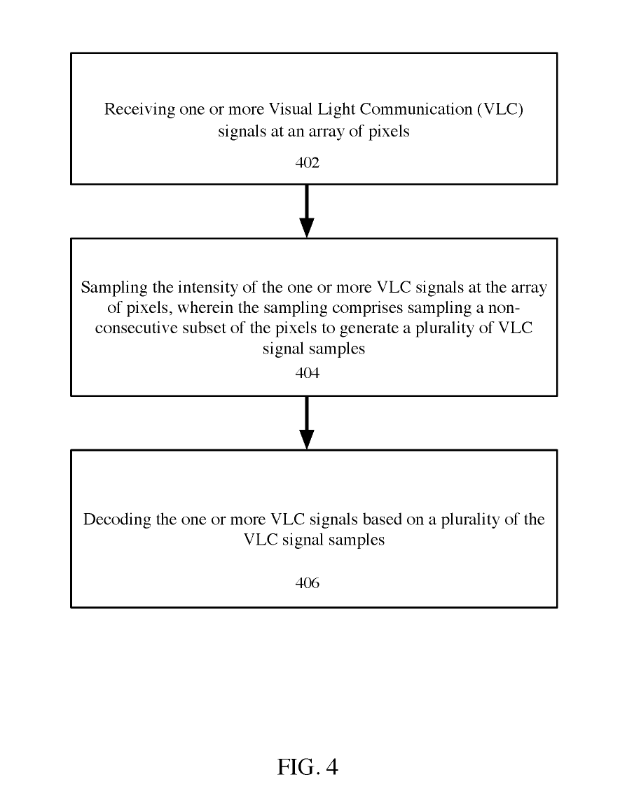

FIG. 4 illustrates a flowchart of an illustrative embodiment for sampling and processing VLC signals via a DI. It should also be appreciated that even though one or more operations are illustrated and/or may be described concurrently and/or with respect to a certain sequence, other sequences and/or concurrent operations may be employed, in whole or in part. In addition, although the description below references particular aspects and/or features illustrated in certain other figures, one or more operations may be performed with other aspects and/or features.

For example, referring to FIG. 4, at block 402, one or more Visual Light Communication (VLC) signals is received at an array of pixels such as pixel array 110, previously described in connection with FIG. 1. At block 404, the intensity of the one or more VLC signals at the array of pixels is sampled, wherein the sampling comprises sampling a non-consecutive subset of the pixels to generate a plurality of VLC signal samples.

In an embodiment, a number of the digital samples representing the one or more light samples may be fewer than a number of pixels in the array. In another implementation, at least some pixels are skipped in one or more lines in the pixel array to generate the digital samples. For example, as described above in connection with portion 205 of a pixel array, every other pixel may be skipped, every third pixel may be skipped, or any other pixels may be skipped so that a non-consecutive subset of the pixels is sampled. At block 406, the one or more VLC signals are decoded based on a plurality of the VLC signal samples. As previously described, a variety of embodiments are possible and intended to be included within claimed subject matter.

Likewise, at block 406, further processing may take place of the remaining measured light signals that include one or more measurements of light signal components and the one or more measurements of VLC signals. For example, as described above, VLC signal measurements (e.g., signal samples) which have been modulated by a light source may be demodulated. Likewise, demodulated light signals (e.g., samples) may further be decoded to obtain an identifier in an embodiment. In one example implementation, a decoded identifier may be used in positioning operations as described above by, for example, associating a location of a light source with a decoded identifier and estimating a location of a mobile device, for example, based at least partially on measurements of VLC signals (e.g., samples).

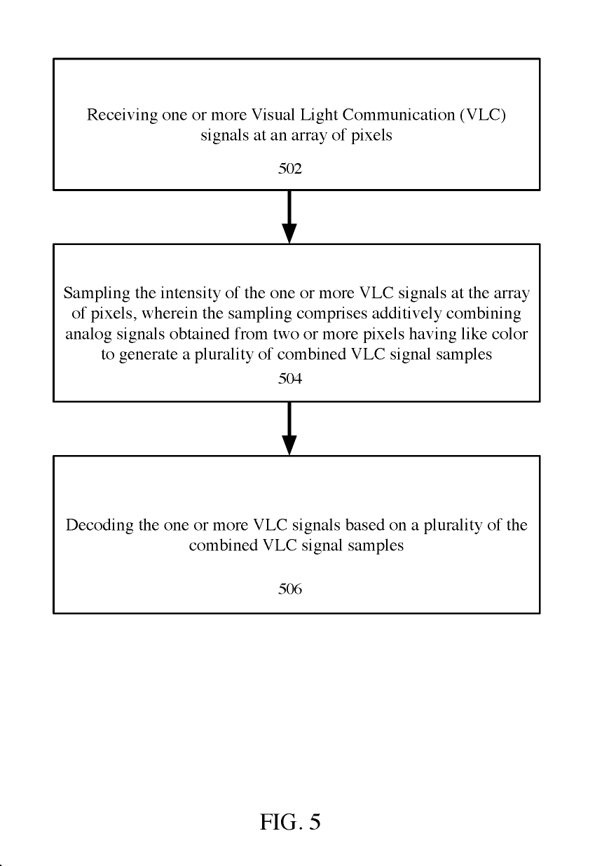

FIG. 5 illustrates a flowchart of another illustrative embodiment for sampling and processing VLC signals via a DI. At block 502 of FIG. 5, one or more Visual Light Communication (VLC) signals is received at an array of pixels such as pixel array 110, previously described. At block 504, the intensity of the one or more VLC signals at the array of pixels is sampled, wherein the sampling comprises additively combining analog signals obtained from two or more pixels having like color to generate a plurality of combined VLC signal samples.

In an embodiment, number of the digital samples representing the one or more light samples may be fewer than a number of pixels in the array. In another non-limiting illustrative embodiment, the digital samples are generated by additively combining analog signals obtained from two or more pixels having like color to generate a single digital sample value. For example, embodiment 300 shown in FIG. 3A illustrates a portion of a pixel array where the analog signals from two like-colored pixels in a line are additively combined to generate a single digital sample value. However, as stated, the number of pixels combined is not limited to two, and the combined pixels do not necessarily have to be in the same line. As another illustrative and non-limiting example, embodiment 310 shown in FIG. 3B illustrates a portion of a pixel array where the analog signals from four like-colored pixels in a line are additively combined to generate a single digital sample value. Again, however, the number of pixels combined is not limited to four, and the combined pixels do not necessarily have to be in the same line. At block 506, the one or more VLC signals is decoded based on a plurality of the combined VLC signal samples. As previously described, a variety of embodiments are possible and intended to be included within claimed subject matter.

At block 506, further processing may take place of the remaining measured light signals that include one or more measurements of light signal components and the one or more measurements of VLC signals. For example, VLC signal measurements (e.g., signal samples) which have been modulated by a light source may be demodulated. Likewise, demodulated light signals (e.g., samples) may further be decoded to obtain an identifier in an embodiment. In one example implementation, a decoded identifier may be used in positioning operations as described above by, for example, associating a location of a light source with a decoded identifier and estimating a location of a mobile device, for example, based at least partially on measurements of VLC signals (e.g., samples).

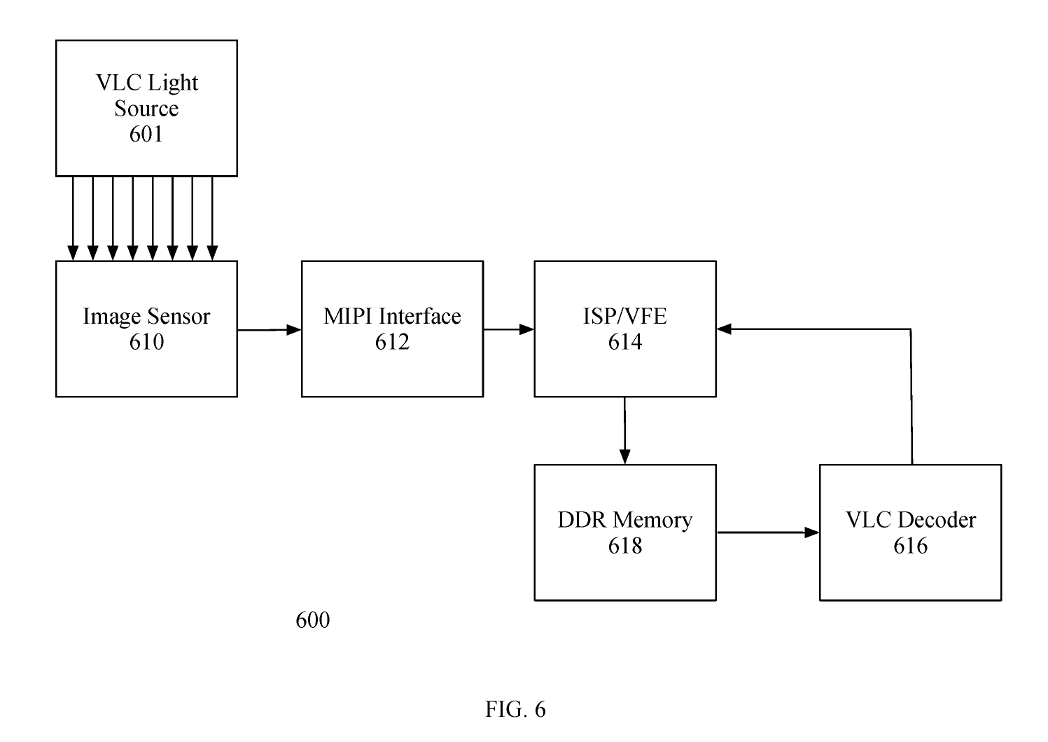

FIG. 6 is a schematic diagram illustrating another embodiment 600 of an architecture for a system including a digital imager. Embodiment 600 is a more specific implementation, again provided merely as an illustration, and not intended to limit claimed subject matter. In many respects, it is similar to previously described embodiments, such as including an array of pixels, at a camera sensor 610, including a signal processor, such as image signal processor 614, and including a memory, such as DDR memory 618. FIG. 6, as shown, illustrates VLC light signals 601 impinging upon sensor 610. For example, at block 402 in FIG. 4 and at block 502 in FIG. 5, an array of pixels receives light signals. It is noted, however, that in embodiment 600, before image signal processor 614, which implements a VFE, as previously described, signals from a pixel array pass via a mobile industry processor interface (MIPI), which provides signal standardization as a convenience. It is noted that the term “MIPI” refers to any and all past, present and/or future MIPI Alliance specifications. MIPI Alliance specifications are available from the MIPI Alliance, Inc. Likewise, after front end processing, signals are provided to memory. VLC light signals, for example, after being provided in memory, may be decoded by decoder 616 and then may return to ISP 614 for further processing. For example, as discussed above in connection with FIGS. 4 and 5, at blocks 406 and 506, respectively, further processing of the light signals may take place.

In a particular implementation, camera sensor 610 may be configurable to operate in multiple different modes of operation including, for example, a first mode of operation to process light signals for image capture and a second mode of operation to process VLC light signals 601. Such a first mode of operation to process light signals may comprise generating one or more frames of digital sample values containing digital sample values for all or substantially all pixels in an array of pixels to be transmitted across MIPI interface 612. Such a second mode of operation, on the other hand, may comprise generating frames of digital sample values containing digital sample values for fewer than an entirety of pixels in an array of pixels to be transmitted across MIPI interface 612. For example, as described above in connection with block 404 of FIG. 4, digital sample values may be generated by sampling non-consecutive pixels in a row. As another illustrative and non-limiting example also described above, at block 504 of FIG. 5, digital sample values may be generated by additively combining analog signals from two or more pixels of like-color in a pixel row. As pointed out above, generating frames of digital sample values containing digital sample values for fewer than an entirety of pixels in an array of pixels to be transmitted across MIPI interface 612 may enable reduced power consumption. As just noted, in particular implementations, the second mode of operation may implement actions at blocks 404 and 504. It should be understood, however, that these are merely examples of how aspects of such a second mode of operation may be implemented, and claimed subject matter is not limited in this respect.

According to an embodiment, camera sensor 610 may be formed, at least in part, on a semiconductor device having electrical contact terminals or “pins” to receive or transmit signals. For example, camera sensor 610 may be configured to be in a particular mode of operation (e.g., either the first or second example modes of operation discussed above) responsive to a signal on a pin. In one particular implementation of block 504, circuitry of camera sensor 610 may be configured to additively combine analog signals from pixels of like color to generate a single digital sample value. In an example implementation in which pixels of camera sensor 610 are formed in part as photodiodes in a CMOS device, for example, transistors may be placed in a particular state to electrical combine analog signals at multiple photodiodes to represent a single combined signal. The single combined signal may then be digitally sampled. It should be understood, however, that this is merely an example of how analog signals from pixels of like color be combined to generate a single digital sample value, and claimed subject matter is not limited in this respect.

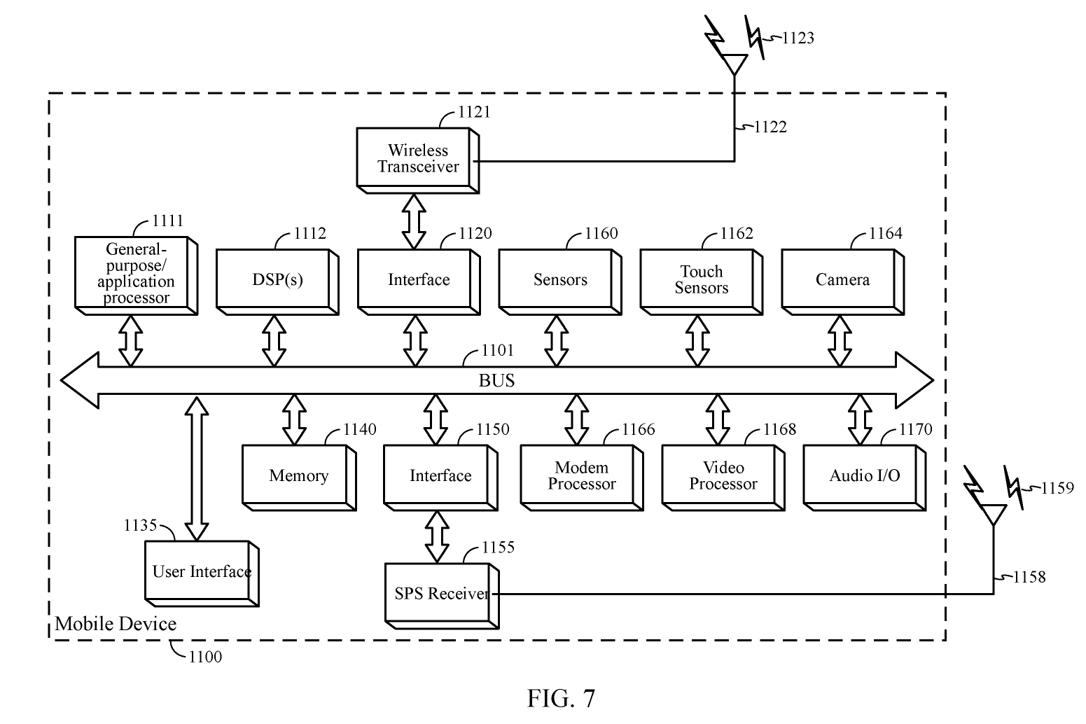

FIG. 7 is a schematic diagram illustrating features of a mobile device according to an embodiment. Subject matter shown in FIG. 7 may comprise features, for example, of a computing device, in an embodiment. It is further noted that the term computing device, in general, refers at least to one or more processors and a memory connected by a communication bus. Likewise, in the context of the present disclosure at least, this is understood to refer to sufficient structure within the meaning of 35 USC § 112(f) so that it is specifically intended that 35 USC § 112(f) not be implicated by use of the term “computing device,” “mobile device,” “wireless station,” “wireless transceiver device” and/or similar terms; however, if it is determined, for some reason not immediately apparent, that the foregoing understanding cannot stand and that 35 USC § 112(f) therefore, necessarily is implicated by the use of the term “computing device,” “mobile device,” “wireless station,” “wireless transceiver device” and/or similar terms, then, it is intended, pursuant to that statutory section, that corresponding structure, material and/or acts for performing one or more actions to be understood and be interpreted to be illustrated in at least in FIGS. 4 and 5, and described in corresponding text of the present disclosure.

In certain embodiments, mobile device 1100 may also comprise a wireless transceiver 1121 which is capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, versions of IEEE Std. 802.11, CDMA, WCDMA, LTE, UMTS, GSM, AMPS, Zigbee, Bluetooth or other wireless communication standards mentioned elsewhere herein, just to name a few examples.

Mobile device 1100 may also comprise SPS receiver 1155 capable of receiving and acquiring SPS signals 1159 via SPS antenna 1158. For example, SPS receiver 1155 may be capable of receiving and acquiring signals transmitted from one global navigation satellite system (GNSS), such as the GPS or Galileo satellite systems, or receiving and acquiring signals transmitted from any one several regional navigation satellite systems (RNSS′) such as, for example, WAAS, EGNOS, QZSS, just to name a few examples. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals for use in performing positioning operations may be performed in memory 1140 or registers (not shown). Mobile device 1100 may provide one or more sources of executable computer instructions in the form of physical states and/or signals (e.g., stored in memory such as memory 1140). In an example implementation, DSP(s) 1112 or general-purpose processor(s) 1111 may fetch executable instructions from memory 1140 and proceed to execute the fetched instructions. DSP(s) 1112 or general-purpose processor(s) 1111 may comprise one or more circuits, such as digital circuits, to perform at least a portion of a computing procedure and/or process. By way of example, but not limitation, DSP(s) 1112 or general-purpose processor(s) 1111 may comprise one or more processors, such as controllers, microprocessors, microcontrollers, application specific integrated circuits, digital signal processors, programmable logic devices, field programmable gate arrays, the like, or any combination thereof. In various implementations and/or embodiments, DSP(s) 1112 or general-purpose processor(s) 1111 may perform signal processing, typically substantially in accordance with fetched executable computer instructions, such as to manipulate signals and/or states, to construct signals and/or states, etc., with signals and/or states generated in such a manner to be communicated and/or stored in memory, for example.

Memory 1140 may also comprise a memory controller (not shown) to enable access of a computer-readable storage medium, and that may carry and/or make accessible digital content, which may include code, and/or computer executable instructions for execution as discussed above. Memory 1140 may comprise any non-transitory storage mechanism. Memory 1140 may comprise, for example, random access memory, read only memory, etc., such as in the form of one or more storage devices and/or systems, such as, for example, a disk drive including an optical disc drive, a tape drive, a solid-state memory drive, etc., just to name a few examples. Under direction of general-purpose processor(s) 1111, DSP(s) 1112, video processor 1168, modem processor 1166 and/or other specialized processors (not shown), a non-transitory memory, such as memory cells storing physical states (e.g., memory states), comprising, for example, a program of executable computer instructions, may be executed by general-purpose processor(s) 1111, memory 1140, DSP(s) 1112, video processor 1168, modem processor 1166 and/or other specialized processors for generation of signals to be communicated via a network, for example. Generated signals may also be stored in memory 1140, also previously suggested.

Memory 1140 may store electronic files and/or electronic documents, such as relating to one or more users, and may also comprise a device-readable medium that may carry and/or make accessible content, including code and/or instructions, for example, executable by general-purpose processor(s) 1111, DSP(s) 1112, video processor 1168, modem processor 1166 and/or other specialized processors and/or some other device, such as a controller, as one example, capable of executing computer instructions, for example. As referred to herein, the term electronic file and/or the term electronic document may be used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

The term “computing device,” in the context of the present disclosure, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present disclosure, may comprise hardware, software, firmware, or any combination thereof (other than software per se). Mobile device 1100, as depicted in FIG. 6, is merely one example, and claimed subject matter is not limited in scope to this particular example.

While mobile device 1100 is one particular example implementation of a computing device, other embodiments of a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, and/or a display with a higher degree of functionality, such as a touch-sensitive color 2D or 3D display, for example.

Also shown in FIG. 7, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, actions may be performed in response execution of one or more executable computer instructions stored in memory 1140 such as on a computer-readable storage medium, such as RAM, ROM, FLASH, or disc drive, just to name a few example. The one or more instructions may be executable by general-purpose processor(s) 1111, DSP(s) 1112, video processor 1168, modem processor 1166 and/or other specialized processors. Memory 1140 may comprise a non-transitory processor-readable memory and/or a computer-readable memory that stores software code (programming code, instructions, etc.) that are executable by processor(s) 1111, DSP(s) 1112, video processor 1168, modem processor 1166 and/or other specialized processors to perform functions described herein. In a particular implementation, wireless transceiver 1121 may communicate with general-purpose processor(s) 1111, DSP(s) 1112, video processor 1168 or modem processor through bus 1101. General-purpose processor(s) 1111, DSP(s) 1112 and/or video processor 1168 may execute instructions to execute one or more aspects of processes, such as discussed above in connection with FIGS. 4A and 4B, for example.

Also shown in FIG. 7, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112, video processor 1168 or general purpose/application processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Dedicated camera device 1164 may comprise, for example an imaging sensor (e.g., charge coupled device or CMOS imager), lens, analog to digital circuitry, frame buffers, just to name a few examples. In embodiments, such as discussed above in connection with blocks 402 and 502 of FIGS. 4 and 5, respectively, the array of pixels that receives light signals may comprise such an imaging sensor. Moreover, the digital samples generated in blocks 404 and 504 of FIGS. 4 and 5, respectively, may also be enabled by such imaging sensors. In one implementation, additional processing, conditioning, encoding or compression of signals representing captured images may be performed at general purpose/application processor 1111 or DSP(s) 1112. For example, as discussed above in connection with blocks 406 and 506 of FIGS. 4 and 5, respectively, further processing of the samples may be performed by such a processor. Of course, this is an illustrative example, and any other suitable processor may be used, as will be discussed. Alternatively, a dedicated video processor 1168 may perform conditioning, encoding, compression or manipulation of signals representing captured images. Additionally, dedicated video processor 1168 may decode/decompress stored image data for presentation on a display device (not shown) on mobile device 1100. Alternatively, this could all be performed by a dedicated VLC processor/decoded in coupled communication with bus 1101. For example, a DSP, ASIC or other device may be employed. In one particular implementation, however, video processor 1168 may be capable of processing signals responsive to light impinging pixels in an imaging sensor (e.g., of camera 1164) exposed to light signals such as VLC light signals. As discussed above, a VLC signal transmitted from a light source may be modulated based, at least in part, on one or more symbols (e.g., a MAC address or a message) that may be detected or decoded at a receiving device. In one implementation, video processor 1168 may be capable of processing signals responsive to light impinging pixels in an imaging sensor to extract or decode symbols modulating VLC light signals (e.g., a MAC address or a message). Furthermore, video processor 1168 may be capable of obtaining a received signal strength measurement or a time of arrival referenced to a synchronized clock based on such processing of signals responsive to light impinging pixels in an imaging sensor for use in positioning operations, for example.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) or general purpose/application processor 1111 in support of one or more applications such as, for example, applications directed to positioning or navigation operations.

In a particular implementation, mobile device 1100 may comprise a dedicated modem processor 1166 capable of performing baseband processing of signals received and downconverted at wireless transceiver 1121 or SPS receiver 1155. Similarly, dedicated modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

What has been described above includes examples of claimed subject matter. It is, of course, not possible to describe every conceivable combination of components and/or methodologies, but one of ordinary skill in the art may recognize that many further combinations and permutations are possible. Accordingly, claimed subject matter is intended to embrace all such alterations, modifications and variations. The detailed disclosure now turns to providing examples that pertain to further embodiments. The examples provided below are illustrative and not intended to be limiting.

Example 1 comprises a mobile device, comprising: means for receiving one or more Visual Light Communication (VLC) signals at an array of pixels; means for sampling the intensity of the one or more VLC signals at the array of pixels, wherein the sampling comprises sampling a non-consecutive subset of the pixels to generate a plurality of VLC signal samples; and means for decoding the one or more VLC signals based on a plurality of the VLC signal samples.

Example 2 is the mobile device of example 1, wherein the array of pixels is to cover a field of view and wherein the VLC signal samples are to substantially cover an entirety of the field of view.

Example 3 is the mobile device of example 2 wherein the sampling a non-consecutive subset of the pixels comprises sampling every other pixel.

Example 4 the mobile device of example 2 wherein the sampling a non-consecutive subset of the pixels comprises sampling every n pixel, where n is an integer between 2 and 100.

Example 5 is the mobile device of example 2 wherein a subset of the pixels in the pixel array are dedicated to measuring VLC signals and a subset of the pixels in the pixel array are dedicated to camera sensor pixels.

Example 6 is the mobile device of example 5, wherein the VLC-dedicated pixels are interleaved with the camera sensor pixels.

Example 7 is the mobile device of example 5, wherein the VLC-dedicated pixels are sampled independently of the camera sensor pixels.

Example 8 is the mobile device of example 5, wherein the VLC-dedicated pixels are sampled in tandem with the camera sensor pixels.

Example 9 is intentionally omitted.

Example 10 comprises means for receiving one or more Visual Light Communication (VLC) signals at an array of pixels; means for sampling the intensity of the one or more VLC signals at the array of pixels, wherein the sampling comprises additively combining analog signals obtained from two or more pixels having like color to generate a plurality of combined VLC signal samples; and means for decoding the one or more VLC signals based on a plurality of the combined VLC signal samples.

Example 11 is the mobile device of example 10, wherein the array of pixels is to cover a field of view and wherein the VLC signal samples are to substantially cover an entirety of the field of view.

Example 12 is the mobile device of example 11, wherein the VLC-dedicated pixels are interleaved with the camera sensor pixels.

Example 13 is the mobile device of example 11, wherein the VLC-dedicated pixels are sampled independently of the camera sensor pixels.

Example 14 is the mobile device of example 11, wherein the VLC-dedicated pixels are sampled in tandem with the camera sensor pixels.

Example 15 is the mobile device of example 11 further comprising: digital sampling circuitry to sample the intensity of the one or more VLC signals at the array of pixels, wherein the sampling comprises additively combining analog signals obtained from two or more pixels having different color to generate a plurality of combined VLC signal samples.

Examples 16-17 are intentionally omitted.

Example 18 is a non-transitory storage medium comprising computer readable instructions stored thereon which are executable by a processor of a mobile device to: receive one or more Visual Light Communication (VLC) signals at an array of pixels; sample the intensity of the one or more VLC signals at the array of pixels, wherein the sampling comprises sampling a non-consecutive subset of the pixels to generate a plurality of VLC signal samples; and decode the one or more VLC signals based on the plurality of VLC signal samples.

Example 19 is the non-transitory storage medium of example 18, wherein the array of pixels is to cover a field of view and wherein the VLC signal samples are to substantially cover an entirety of the field of view.

Example 20 is the non-transitory storage medium of example 19, wherein the sampling a non-consecutive subset of the pixels comprises sampling every other pixel.

Example 21 is the non-transitory storage medium of example 19, wherein the sampling a non-consecutive subset of the pixels comprises sampling every n pixel, where n is an integer between 2 and 100.

Example 22 is the non-transitory storage medium of example 19, wherein a subset of the pixels in the pixel array are dedicated to measuring VLC signals and a subset of the pixels in the pixel array are dedicated to camera sensor pixels.

Example 23 is the non-transitory storage medium of example 22, wherein the VLC-dedicated pixels are interleaved with the camera sensor pixels.

Example 23A is the non-transitory storage medium of example 22, wherein the VLC-dedicated pixels are sampled independently of the camera sensor pixels.

Example 23B is the non-transitory storage medium of example 22, wherein the VLC-dedicated pixels are sampled in tandem with the camera sensor pixels.

Example 24 is a non-transitory storage medium comprising computer readable instructions stored thereon which are executable by a processor of a mobile device to: receive one or more Visual Light Communication (VLC) signals at an array of pixels; sample the intensity of the one or more VLC signals at the array of pixels, wherein the sampling comprises additively combining analog signals obtained from two or more pixels having like color to generate a plurality of combined VLC signal samples; and decode the one or more VLC signals based on the plurality of combined VLC signal samples.

Example 25 is the non-transitory storage medium of example 24, wherein the array of pixels is to cover a field of view and wherein the VLC signal samples are to substantially cover an entirety of the field of view.

Example 26 is the non-transitory storage medium of example 25, wherein a subset of the pixels in the pixel array are dedicated to measuring VLC signals and a subset of the pixels in the pixel array are dedicated to camera sensor pixels.

Example 27 is the non-transitory storage medium of example 26, wherein the VLC-dedicated pixels are interleaved with the camera sensor pixels.

Example 28 is the non-transitory storage medium of example 26, wherein the VLC-dedicated pixels are sampled independently of the camera sensor pixels.

Example 29 is the non-transitory storage medium of example 26, wherein the VLC-dedicated pixels are sampled in tandem with the camera sensor pixels.

Example 30 is the non-transitory storage medium of example 25, further comprising: sampling the intensity of the one or more VLC signals at the array of pixels, wherein the sampling comprises additively combining analog signals obtained from two or more pixels having different color to generate a plurality of combined VLC signal samples.

In the context of the present disclosure, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other electrical conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components or memory states, as examples, necessarily implies that memory, such memory components and/or memory states, continuing with the example, is tangible.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements or identical results, unless otherwise expressly indicated.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

Wireless communication techniques described herein may be employed in connection with various wireless communications networks such as a wireless wide area network (“WWAN”), a wireless local area network (“WLAN”), a wireless personal area network (WPAN), and so on. In this context, a “wireless communication network” comprises multiple devices or nodes capable of communicating with one another through one or more wireless communication links. The term “network” and “communication network” may be used interchangeably herein. A VLC communications network may comprise a network of devices employing visual light communications. A WWAN may comprise a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, or 4G) cellular technology and/or the like, whether currently known and/or to be later developed. Network access technologies may enable wide area coverage for devices, such as computing devices and/or network devices, with varying degrees of mobility, for example.

As used herein, the term “access point” is meant to include any wireless communication station and/or device used to facilitate access to a communication service by another device in a wireless communications system, such as, for example, a WWAN, WLAN or WPAN, although the scope of claimed subject matter is not limited in this respect. In another aspect, an access point may comprise a WLAN access point, cellular base station or other device enabling access to a WPAN, for example. Likewise, as previously discussed, an access point may also engage in VLC communications.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

In the context of the present disclosure, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in a non-transitory memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

Also, for one or more embodiments, an electronic document and/or electronic file may comprise a number of components. As previously indicated, in the context of the present disclosure, a component is physical, but is not necessarily tangible. As an example, components with reference to an electronic document and/or electronic file, in one or more embodiments, may comprise text, for example, in the form of physical signals and/or physical states (e.g., capable of being physically displayed and/or maintained as a memory state in a tangible memory). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed and/or maintained as a memory state in a tangible memory). In an embodiment, digital content may comprise, for example, text, images, audio, video, haptic content and/or other types of electronic documents and/or electronic files, including portions thereof, for example.

Also, in the context of the present disclosure, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this disclosure, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present disclosure, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present disclosure, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

As suggested previously, communications between a computing device and/or a network device and a wireless network may be performed in accordance with known and/or to be developed network protocols including, for example, wireless communication protocols mentioned above. A computing device and/or a networking device may also have a subscriber identity module (SIM) card, which, for example, may comprise a detachable or embedded smart card that is able to store subscription content of a user, and/or is also able to store a contact list. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

Algorithmic descriptions and/or symbolic representations are examples of techniques used by those of ordinary skill in the signal processing and/or related arts to convey the substance of their work to others skilled in the art. An algorithm is, in the context of the present disclosure, and generally, is considered to be a self-consistent sequence of operations and/or similar signal processing leading to a desired result. In the context of the present disclosure, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular disclosure, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

In an embodiment, implementation may be achieved via a non-transitory storage medium comprising computer readable instructions stored thereon which are executable by a processor to: receive one or more Visual Light Communication (VLC) signals at an array of pixels; sample an intensity of the one or more VLC signals at the array of pixels, wherein the sampling is to comprise additively combining analog signals obtained from two or more pixels having like color to generate a plurality of combined VLC signal samples; and decode the one or more VLC signals based on the plurality of combined VLC signal samples.

In an embodiment, implementation may be achieved via a mobile device comprising: means for receiving one or more Visual Light Communication (VLC) signals at an array of pixels; means for sampling an intensity of the one or more VLC signals at the array of pixels, wherein the sampling comprises additively combining analog signals obtained from two or more pixels having like color to generate a plurality of combined VLC signal samples; and means for decoding the one or more VLC signals based on the plurality of combined VLC signal samples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. A method at a mobile device comprising:
receiving one or more Visual Light Communication (VLC) signals at an array of pixels of an image sensor configurable to operate in a first mode of operation for image capture or a second mode of operation to process the one or more VLC signals;
sampling an intensity of the one or more VLC signals at the array of pixels while the image sensor is operating in the second mode, wherein the sampling comprises sampling a non-consecutive subset of pixels in the array of pixels to generate a plurality of VLC signal samples; and
decoding the one or more VLC signals based on at least some of the plurality of VLC signal samples.

2. The method of claim 1, wherein the array of pixels is to cover a field of view and wherein the plurality of VLC signal samples are to substantially cover an entirety of the field of view.

3. The method of claim 2, wherein the sampling the non-consecutive subset of pixels in the array of pixels comprises sampling every n pixel, where n is an integer between 1 and 100.

4. The method of claim 2, wherein a first subset of pixels in the array of pixels are dedicated to measuring VLC signals while the image sensor is operating in the second mode and a second subset of pixels in the array of pixels are dedicated to camera sensor pixels while the image sensor is operating in the first mode.

5. The method of claim 4, wherein the first subset of pixels in the array of pixels are interleaved with the second subset of pixels in the array of pixels.

6. The method of claim 4, wherein the first subset of pixels in the array of pixels are sampled independently of the second subset of pixels in the array of pixels.

7. The method of claim 4, wherein the first subset of pixels in the array of pixels are sampled in tandem with the second subset of pixels in the array of pixels.

8. A method at a mobile device comprising:
receiving one or more Visual Light Communication (VLC) signals at an array of pixels;
sampling an intensity of the one or more VLC signals at the array of pixels, wherein the sampling comprises additively combining analog signals obtained from two or more pixels in the array of pixels having like color to generate a plurality of combined VLC signal samples; and
decoding the one or more VLC signals to obtain an identifier based on at least some of the plurality of combined VLC signal samples comprising the analog signals obtained from the two or more pixels in the array having like color.

9. The method of claim 8, wherein the array of pixels is to cover a field of view and wherein the plurality of combined VLC signal samples are to substantially cover an entirety of the field of view.

10. The method of claim 9, wherein a first subset of pixels in the array of pixels are dedicated to measuring VLC signals and a second subset of pixels in the array of pixels are dedicated to camera sensor pixels.

11. The method of claim 10, wherein the first subset of pixels in the array of pixels are interleaved with the second subset of pixels in the array of pixels.

12. The method of claim 10, wherein the first subset of pixels in the array of pixels are sampled independently of the second subset of pixels in the array of pixels.

13. The method of claim 10, wherein the first subset of pixels in the array of pixels are sampled in tandem with the second subset of pixels in the array of pixels.

14. The method of claim 9, further comprising:
sampling the intensity of the one or more VLC signals at the array of pixels, wherein the sampling comprises additively combining the analog signals obtained from the two or more pixels having different color to generate at least a portion of the plurality of combined VLC signal samples.

15. A mobile device comprising:
an image sensor configurable to operate in a first mode of operation for image capture or a second mode of operation to process the one or more Visual Light Communication (VLC) signals, the image sensor comprising:
an array of pixels to receive one or more VLC signals; and
digital sampling circuitry to sample an intensity of the one or more VLC signals at the array of pixels while the image sensor operates in the second mode of operation, wherein the sampling comprises sampling a non-consecutive subset of pixels in the array of pixels to generate a plurality of VLC signal samples; and
decoding circuitry to decode the one or more VLC signals based on the plurality of VLC signal samples.

16. The mobile device of claim 15, wherein the array of pixels is to cover a field of view and wherein the plurality of VLC signal samples are to substantially cover an entirety of the field of view.

17. The mobile device of claim 16, wherein the sampling the non-consecutive subset of pixels in the array of pixels comprises sampling every n pixel, where n is an integer between 1 and 100.

18. The mobile device of claim 16, wherein a first subset of pixels in the array of pixels are dedicated to measuring VLC signals and a second subset of pixels in the array of pixels are dedicated to image capture.

19. The mobile device of claim 18, wherein the first subset of pixels in the array of pixels are interleaved with the second subset of pixels in the array of pixels.

20. The mobile device of claim 18, wherein the first subset of pixels in the array of pixels are sampled independently of the second subset of pixels in the array of pixels.

21. The mobile device of claim 18, wherein the first subset of pixels in the array of pixels are sampled in tandem with the second subset of pixels in the array of pixels.

22. A mobile device comprising:
an array of pixels configured to receive one or more Visual Light Communication (VLC) signals;
digital sampling circuitry to sample an intensity of the one or more VLC signals at the array of pixels, wherein the sampling comprises additively combining analog signals obtained from two or more pixels having like color to generate a plurality of combined VLC signal samples; and
decoding circuitry to decode the one or more VLC signals to obtain an identifier based on the plurality of combined VLC signal samples comprising the analog signals obtained from the two or more pixels in the array having like color.

23. The mobile device of claim 22 wherein the array of pixels is to cover a field of view and wherein the plurality of combined VLC signal samples are to substantially cover an entirety of the field of view.

24. The mobile device of claim 23, wherein a first subset of pixels in the array of pixels are dedicated to measuring VLC signals and a second subset of pixels in the array of pixels are dedicated to camera sensor pixels.

25. The mobile device of claim 24, wherein the first subset of pixels in the array of pixels are interleaved with the second subset of pixels in the array of pixels.

26. The mobile device of claim 24, wherein the first subset of pixels in the array of pixels are sampled independently of the second subset of pixels in the array of pixels.

27. The mobile device of claim 24, wherein the first subset of pixels in the array of pixels are sampled in tandem with the second subset of pixels in the array of pixels.

28. The mobile device of claim 22, and further comprising:
digital sampling circuitry to sample the intensity of the one or more VLC signals at the array of pixels, wherein the sampling comprises additively combining the analog signals obtained from the two or more pixels having different color to generate at least a portion of the plurality of combined VLC signal samples.

29. The method of claim 1, and further comprising transmitting the VLC signal samples in frames comprising digital sample values for less than an entirety of pixels in the array of pixels over a mobile industry processor interface (MIPI).

30. The method of claim 8, and further comprising transmitting the VLC signal samples in frames comprising digital sample values for less than an entirety of pixels in the array of pixels over a mobile industry processor interface (MIPI).
